(19) United States
(12) Patent Application Publication
(10) Pub. No.: US 2016/0148288 A1
(43) Pub. Date: May 26, 2016

(54) METHOD, SYSTEM, AND PROGRAM FOR OPTIMAL PRICING OF INTERNATIONAL TICKETS OF A TRAVEL ITINERARY

(71) Applicant: Edward Jay TOBIN, Pasadena, CA (US)

(72) Inventor: Edward Jay TOBIN, Pasadena, CA (US)

(21) Appl. No.: 14/551,468

(22) Filed: Nov. 24, 2014

(51) Int. Cl. G06Q 30/02; G06Q 50/14; G06Q 10/02

(52) U.S. Cl. CPC G06Q 30/0283; G06Q 10/02; G06Q 50/14

(57) ABSTRACT

An optimal pricing system for calculating the price of travel itinerary tickets in two or more markets is provided. The optimal pricing system may include a computer and a program product comprising machine-readable program code for causing, when executed, the computer to perform the following process steps: prompting a user to transmit a plurality of itinerary information and a plurality of traveler information; receiving the plurality of itinerary information and a plurality of traveler information, wherein plurality of itinerary information comprises departure location criteria, destination location criteria, and travel criteria of the travel itinerary, and wherein the plurality of traveler information comprises a home country market location and a current market location of the traveler; identifying a international component from the departure location criteria and the destination location criteria; and calculating the least expensive price of tickets for the travel itinerary substantially satisfying the plurality of itinerary information based the departure location criteria, the home country market location and the current market location.

### BACKGROUND OF THE INVENTION

The present invention relates to the field of pricing and selling of travel itinerary tickets and, more particularly, to offering and facilitating the purchase of the lowest price available for travel, a travel itinerary and the associated tickets based on relevant geographic market places.

Currently, corporate travelers and/or their travel booking agents often cannot use their negotiated discounts on a travel itinerary or airline ticket when the traveler's point of sale country is not the same as the origin country of the travel itinerary, as these discounts often are only applicable if purchased in the trip origin market. As a result, the traveler is offered a more expensive trip had this traveler bought the trip in the origin country of the travel itinerary. Additionally the traveler may be missing out on lower prices available in the local market or the ability to take advantage of favorable foreign exchange.

Current systems price airline tickets based on the traveler's point of sale country and often miss out on corporate discounts or other less expensive prices available for travel purchased in the origin country. This often results in a traveler paying more for their travel or airline booking had they purchased the ticket in the optimal market.

As can be seen, there is a need for a method, system and program that will identify and facilitate payment for travel itinerary and the associated tickets in the optimal market with the least expensive pricing.

### SUMMARY OF THE INVENTION

In one aspect of the present invention, a system for determining a price of at least one ticket for a travel itinerary for a traveler, comprises a computer having a user interface; and a program product comprising machine-readable program code for causing, when executed, the computer to perform the following process steps: receiving a plurality of itinerary information and a plurality of traveler information, wherein plurality of itinerary information comprises departure location criteria, destination location criteria, and travel criteria of the travel itinerary, and wherein the plurality of traveler information comprises a home market location and a current market location of the traveler; identifying a international component from the departure location criteria and the destination location criteria; and calculating a pricing option of the at least one ticket offered from each of a plurality of relevant markets, wherein each ticket substantially satisfying the plurality of itinerary information, and wherein the relevant markets comprise the departure location criteria country, departure location criteria country, the home market location country and the current market location country.

In another aspect of the present invention, a system for determining a price of at least one ticket for a travel itinerary for a traveler, comprises a computer having a user interface; and a program product comprising machine-readable program code for causing, when executed, the computer to perform the following process steps: prompting a user to transmit a plurality of itinerary information and a plurality of traveler information; receiving the plurality of itinerary information and a plurality of traveler information, wherein plurality of itinerary information comprises departure location criteria, destination location criteria, and travel criteria of the travel itinerary, and wherein the plurality of traveler information comprises a home market location and a current market location of the traveler; identifying a international component from the departure location criteria and the destination location criteria; calculating a pricing option of the at least one ticket offered from each of a plurality of relevant markets, wherein each pricing option is calculated by routing the associated travel itinerary through at least one travel booking tool located in each relevant market, wherein each ticket substantially satisfying the plurality of itinerary information, and wherein the relevant markets comprise the departure location criteria country, departure location criteria country, the home market location country and the current market location country; determining the least expensive pricing option after the application of a plurality of discounts; and determining the difference among the pricing options offered from each of the plurality of relevant markets.

These and other features, aspects and advantages of the present invention will become better understood with reference to the following drawings, description and claims.

### BRIEF DESCRIPTION OF THE DRAWINGS

FIG. 1 is a flowchart of the prior art;

FIG. 2A is the first part of a flowchart of an exemplary embodiment of the present invention; and

FIG. 2B is the second part of the flowchart of the exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an optimal pricing system for calculating the price of travel itinerary and the associated tickets in two or more markets. The optimal pricing system may include a computer and a program product comprising machine-readable program code for causing, when executed, the computer to perform the following process steps: prompting a user to transmit a plurality of itinerary information and a plurality of traveler information; receiving the plurality of itinerary information and a plurality of traveler information which may be accessed from other databases such as a traveler profile database, wherein plurality of itinerary information comprises departure location criteria, destination location criteria, and travel criteria of the travel itinerary, and wherein the plurality of traveler information comprises a home country market location and a current market location of the traveler; identifying a international component from the departure location criteria and the destination location criteria; and calculating the least expensive price of tickets for the travel itinerary substantially satisfying the plurality of itinerary information based the departure location criteria, the home country market location and the current market location.

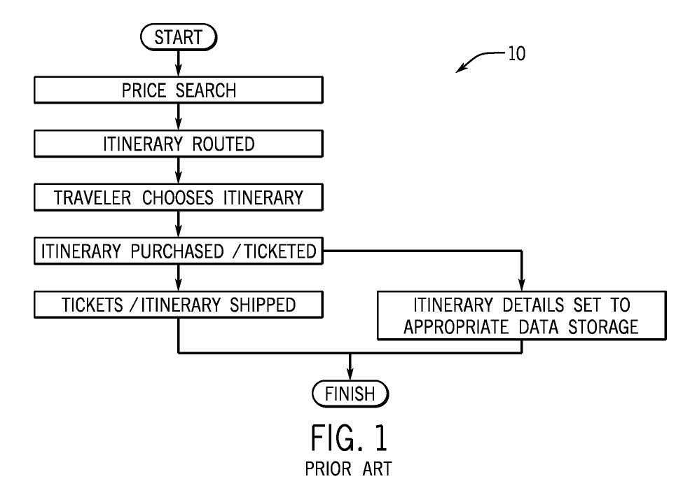

FIG. 1 illustrates the prior art method of pricing airline tickets. Current airline booking systems 10 calculate a price based on at least in part the traveler's point of sale country. The calculated prices and their associated travel itinerary are routed to the traveler, so that the traveler can purchase the travel itinerary ticket whose price is based on the point of sale country. The purchased travel itinerary and associated ticket are shipped and/or transmitted to the appropriate data storage means.

The present invention recognizes when there may be a gap in travel itinerary prices between point of sale markets and other markets relevant to the travel itinerary due to the applicability of discounts or other market conditions. Specifically, the present invention is advantageous over the prior art as it will identify and book travel itinerary tickets in the relevant market with the least expensive pricing.

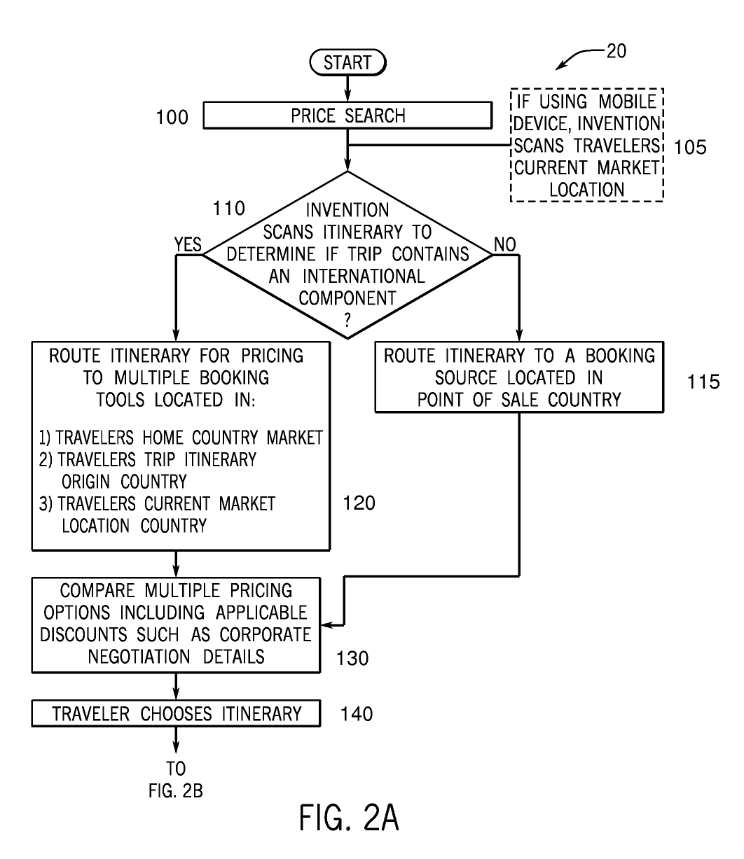

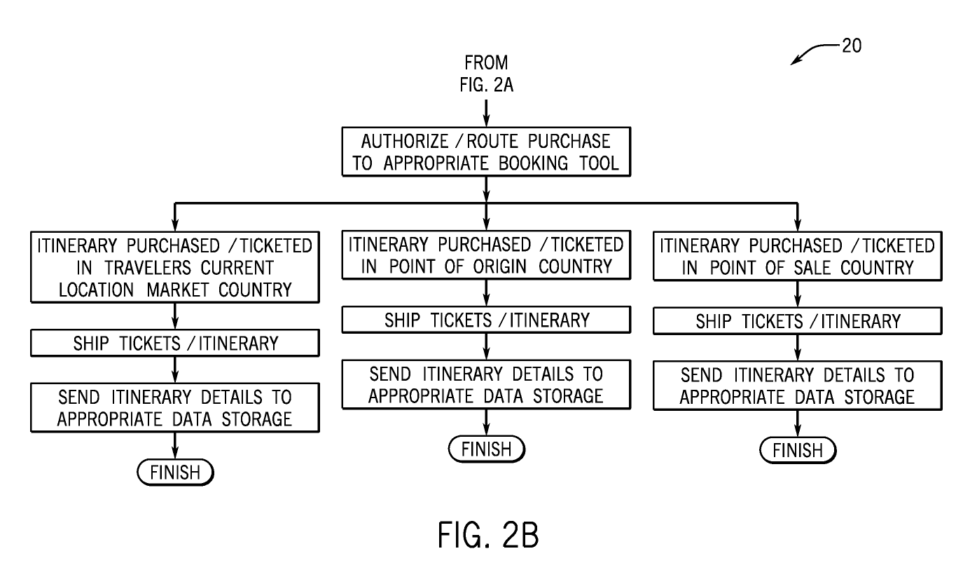

FIG. 2A and 2B illustrates a novel optimal pricing system 20 that embodies the method and program of the present invention for use in calculating the price of travel itinerary tickets in the optimal relevant market.

The optimal pricing system 20 may include at least one computer with a user interface. The computer may include any computer having at least one processor and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The user interface may be adapted for communicating with the program product a plurality of itinerary information and a plurality of traveler information. The plurality of itinerary information may include departure location criteria, at least one destination location criteria, and travel criteria of a travel itinerary. The travel itinerary may include, but not limited to, airline flights, travel by sea, land-based travel and the like. The travel criteria may include, but not be limited to, the acceptable and preferred days and times of travel. The plurality of traveler information may include demographic data, a home country market location, a current market location and the like of the traveler of the travel itinerary.

In step 100, the plurality of itinerary information and the plurality of traveler information may be input through the user interface or otherwise transmitted to the program product via a global distribution system, a travel booking tool and/or the like. The travel booking tool may be an online or physical travel agency such as Travelocity, Orbitz, Expedia and the like.

When the optimal pricing system 20 receives the plurality of itinerary information and plurality of traveler information, the program product may compare the departure location and the destination location so as to determine if travel itinerary involves an international component, in step 110, for example when the departure location and the destination location are located in different countries. If the travel itinerary involves an international component, the program product may identify the departure location (origin country) and the at least one destination location (being mindful of open-jaw and similar multiple destination travel itineraries) of the travel itinerary and the current location (point of sale country) and the home country market of the traveler. Otherwise, the program product may use the point of sale country when determining a price for the at least one travel itinerary ticket, in step 115.

In certain embodiments, the program product may receive the point of sale country if the traveler is utilizing a mobile device that allows its current location to be determined by the program product, in step 105. In certain embodiments, the program product may receive the home country market location through accessing social networks associated with the traveler, including but not limited to Facebook, Linkedln, and the like as well as traveler profiles which may reside in a corporate database. If the point of sale country and the origin country do not match, then the program product may be adapted to separately price at least one ticket that substantially satisfies the plurality of itinerary information by routing the travel itinerary to a plurality of travel booking tools located in relevant markets: a) the point of sale market; b) the origin country market; c) the home country market and d) the at least one destination country, in step 120.

In step 130, the program product may determine which relevant market provides the least expensive pricing option before and after applying a plurality of discounts. The plurality of discounts may include, but not be limited to, corporate discounts, foreign exchange costs, distribution and administrative costs as well as any other necessary factors.

Once the program product determines the least expensive country to book or purchase the travel booking itinerary, the program product electronically represents the at least one ticket that substantially satisfies the plurality of itinerary information of the travel itinerary that are associated with the least expensive country for the traveler to choose, in step 140. Such electronic representation may be on the user interface.

As illustrated in FIG. 2B, once the at least one ticket is selected by the traveler, the optimal pricing system 20 issues the at least one ticket via the standard methodology, usually electronically. The optimal pricing system 20 then sends the trip details including any savings generated by the methodology to the appropriate data reconciliation system for reporting.

The optimal pricing system 20 may be applicable to other segments of the travel industry, including but not limited to lodging, hotels, social events, restaurants selections, and other situations where recognition of multiple opportunities exist to price such selections.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for determining a price of at least one ticket for a travel itinerary for a traveler, comprising:
a computer having a user interface; and
a program product comprising machine-readable program code for causing, when executed, the computer to perform the following process steps:
receiving a plurality of itinerary information and a plurality of traveler information, wherein plurality of itinerary information comprises departure location criteria, destination location criteria, and travel criteria of the travel itinerary, and wherein the plurality of traveler information comprises a home market location and a current market location of the traveler;
identifying an international component from the departure location criteria and the destination location criteria; and
calculating a pricing option of the at least one ticket offered from each of a plurality of relevant markets,
wherein each ticket substantially satisfying the plurality of itinerary information, and
wherein the relevant markets comprise the departure location criteria country, departure location criteria country, the home market location country and the current market location country.

2. The system of claim 1, wherein each pricing option is calculated by routing the associated travel itinerary through at least one travel booking tool located in each relevant market.

3. The system of claim 1, further providing the step of determining the difference among the pricing options offered from each of the plurality of relevant markets.

4. The system of claim 1, further providing the step of determining the least expensive pricing option.

5. The system of claim 1, further providing the step of determining the least expensive pricing option after the application of a plurality of discounts.

6. The system of claim 5, wherein the plurality of discounts comprises corporate discounts.

7. The system of claim 6, wherein the plurality of discounts comprises corporate foreign exchange costs.

8. The system of claim 7, wherein the plurality of discounts comprises distribution costs.

9. The system of claim 8, wherein the plurality of discounts comprises administrative costs.

10. The system of claim 1, further providing the step of prompting a user to transmit the plurality of itinerary information and the plurality of traveler information.

11. The system of claim 1, further providing the step of routing the selected and/or least expensive pricing option to an appropriate booking tool for purchase.

12. A system for determining a price of at least one ticket for a travel itinerary for a traveler, comprising:
a computer having a user interface; and
a program product comprising machine-readable program code for causing, when executed, the computer to perform the following process steps:
prompting a user to transmit a plurality of itinerary information and a plurality of traveler information;
receiving the plurality of itinerary information and a plurality of traveler information, wherein plurality of itinerary information comprises departure location criteria, destination location criteria, and travel criteria of the travel itinerary, and wherein the plurality of traveler information comprises a home market location and a current market location of the traveler;
identifying an international component from the departure location criteria and the destination location criteria;
calculating a pricing option of at least one ticket offered from each of a plurality of relevant markets, wherein each pricing option is calculated by routing the associated travel itinerary through at least one travel booking tool located in each relevant market, wherein each ticket substantially satisfying the plurality of itinerary information, and wherein the relevant markets comprise the departure location criteria country, departure location criteria country, the home market location country and the current market location country;
determining the least expensive pricing option after the application of a plurality of discounts; and
determining the difference among the pricing options offered from each of the plurality of relevant markets.
